(19) United States
(12) Patent Application Publication
(10) Pub. No.: US 2004/0060214 A1
(43) Pub. Date: Apr. 1, 2004

(54) Spinning sign

(76) Inventor: Rosalie Hanley, Twentynine Palms, CA (US)

Correspondence Address: LAW OFFICES OF CLEMENT CHENG, 17220 NEWHOPE STREET #127, FOUNTAIN VALLEY, CA, 92708, US

(21) Appl. No.: 10/662,701

(22) Filed: Sep. 15, 2003

Related U.S. Application Data
(60) Provisional application No. 60/411,675, filed on Sep. 17, 2002.

(51) Int. Cl. G09F 11/02

(52) U.S. Cl. 40/479

(57) ABSTRACT

The current invention is a wind driven spinning display sign. It has a shape that causes it to spin in wind coming from any direction. This unique shape also allows it to display text and images clearly in 360 degrees of direction while spinning. The device can be a decorative device for automobile antennas, to display colors, personalized messages, images, or advertisements.

### BACKGROUND

Spinning advertising has been used in many applications to attract attention of consumers. Previous wind driven signs have been limited to very narrow signs because they could not harness enough wind power to turn a very wide sign on a vertical axis. Currently, very wide wind driven signs have to be suspended on a horizontal axis and supported on both ends, resulting in a sign that is flipping over and over rather than spinning on a vertical axis. The car is a good generator of a wind environment, but automobile advertising has been limited to antenna balls, streamers and banners.

### BRIEF DESCRIPTION OF THE DRAWINGS

FIG. 1 is a top view of the present invention

FIG. 2 is a perspective view

FIG. 3 is a front view

FIG. 4 is an exploded view of the laminate embodiment

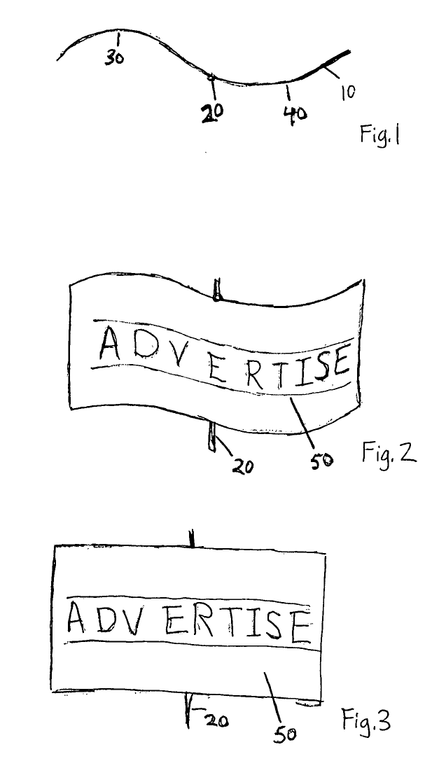

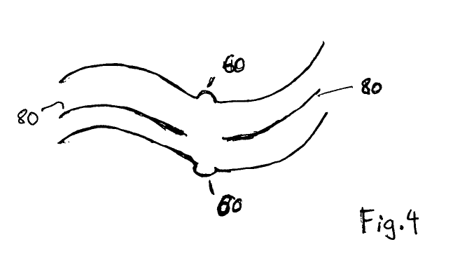

### DISCLOSURE OF INVENTION

The current invention is a wind driven spinning display sign. It has a shape that causes it to spin in wind coming from any direction. This unique shape also allows it to display text and images clearly in 360 degrees of direction while spinning. The device can be a decorative device for automobile antennas, to display colors, personalized messages, images, or advertisements. It can also be used in large and small signs as well as yard and garden decorations. It can be made of metal, wood or plastic in a complete, range of designs and sizes.

The spinning sign has a sinusoidal profile sign body having a pair of opposed sides, each showing a personalized display of colors, images, personalized messages or advertisements. The wind gathering shape sign body 10 spins the sign in wind. Each side displays a concave half 30 and a convex half 40. The sign body 10 can be formed as a planar sheet. The sheet is then formed in a sinusoidal wave shape. The dual display surface 50 can be the same or different images.

The central axis can be horizontal or vertical. The preferred embodiment utilizes a central vertical axis. The central axis is a line passing through the center of the sign body. Therefore, the distance between the vertical axis and to the left edge of the sign is the same as is the distance between the vertical axis and the right edge of the sign. The central axis of rotation defined through the sign body receives an axle such as a rod or car antenna.

A pair of sinusoidal profile sign bodies can attach to each other and form a central axis of rotation through the sign body. The axis defines a groove formed by the pair of sinusoidal profile sign bodies when secured around an axle. The spinning sign forms a pair of opposed sides, each side displaying a concave half and a convex half. The sinusoidal profile can be seen from above when the sign is at rest.

An alternate laminate embodiment, the sign body is made by a pair of sign bodies hinged and attached along one side so that they fold together to form the sign. The alternate embodiment sign can be closed and attachable by adhesive.

Manufacturing methods include using two sheets of stamped metal FIG. 4. The sign body can be made of two sheets of stamped metal. The metal is stamped to shape with a channel formed in the center at the point of axis. The two sheets of metal are joined together with an adhesive placing the axle channel over the axle or auto antenna. Also, the sign can be made of molded plastic in two pieces. The plastic pieces are molded with an axle channel 60. They would be joined together with an adhesive placing the axle channel over the axle or auto antenna. Finally, the device can be made from one piece in plastic with the axle channel molded into the device. The adhesive can be added in the form of a strip 80 or liquid.

### CALL OUT LIST OF THE ELEMENTS

10 Wind Gathering Shape Sign Body

20 Axis

30 Concave Area

40 Convex Area

50 A Display Areas

60 Axle Channel

80 Adhesive Strip

1. A spinning sign comprising: a sinusoidal profile sign body having a pair of opposed sides, each side displaying a concave half and a convex half; a central axis of rotation defining an axle channel through the sign body.

2. The sign in claim 1 wherein the pair of sign bodies is hingedly attached along one side so that they fold together to form the sign.

3. The sign in claim 1 wherein the pair of sign bodies is attachable by adhesive.

4. A spinning sign comprising: a pair of sinusoidal profile sign bodies attachable to each other; a central axis of rotation defined through the sign body, the axis defining a groove formed by the pair of sinusoidal profile sign bodies when secured around an axle, wherein said spinning sign forms a pair of opposed sides, each side displaying a concave half and a convex half; the sign having a sinusoidal profile.

5. The sign in claim 4 wherein the pair of sign bodies is hingedly attached along one side so that they fold together to form the sign.

6. The sign in claim 4 wherein the pair of sign bodies is attachable by adhesive.
